(19) United States
(12) Patent Application Publication
(10) Pub. No.: US 2022/0147613 A1
(43) Pub. Date: May 12, 2022

(54) AUTOMATIC PASSWORD EXPIRATION BASED ON PASSWORD INTEGRITY

(71) Applicant: Hewlett-Packard Development Company, L.P., Spring, TX (US)

(72) Inventors: Paul Michael Anderson, Fort Collins, CO (US); Leonardo Eloy Abranques de Oliveira, Fort Collins, CO (US); Christopher Ray Myers, Vancouver, WA (US); Shane l. Saunders, Fort Collins, CO (US)

(73) Assignee: Hewlett-Packard Development Company, L.P., Spring, TX (US)

(21) Appl. No.: 17/418,509

(22) PCT Filed: Jul. 19, 2019
(86) PCT No.: PCT/US2019/042568

§ 371 Date: Jun. 25, 2021

(51) Int. Cl. G06F 21/46; G06F 21/55

(52) U.S. Cl. CPC G06F 21/46; G06F 2221/034; G06F 21/552

(57) ABSTRACT

Examples of automatic password expiration based on password integrity are described. In an example, a password may be sent to a password integrity system to evaluate the password against integrity criteria. An integrity score for the password and scoring characteristics indicating the integrity criteria that contributed to the integrity score may be received from the password integrity system. The password may be automatically expired in response to the integrity score being less than an integrity threshold.

### BACKGROUND

Passwords may be used by computing devices to authenticate a user or application. Passwords may be a secret that is shared to confirm the identity of a user or application. In some examples, a password may be used in an authentication process in which a user or application establishes their identity to gain access to a resource or system. Many authentication systems use password-based authentication.

### BRIEF DESCRIPTION OF THE DRAWINGS

Various examples will be described below by referring to the following figures.

FIG. 1 is a block diagram of an example of a computing device that may perform automatic password expiration based on password integrity;

FIG. 2 is a flow diagram illustrating an example of a method for automatic password expiration based on password integrity;

FIG. 3 is a flow diagram illustrating another example of a method for automatic password expiration based on password integrity;

FIG. 4 is a flow diagram illustrating yet another example of a method for automatic password expiration based on password integrity; and

FIG. 5 is a sequence diagram for an example of automatic password expiration based on password integrity.

Throughout the drawings, identical reference numbers designate similar, but not necessarily identical, elements. The figures are not necessarily to scale, and the size of some parts may be exaggerated to more clearly illustrate the example shown. Moreover the drawings provide examples and/or implementations in accordance with the description; however, the description is not limited to the examples and/or implementations provided in the drawings.

### DETAILED DESCRIPTION

The techniques described herein relate to automatic password expiration based on password integrity. As used herein a “password” is secret information that is associated with a particular user or application (e.g., a program implemented by a computing device). A password may include a phrase (e.g., character, numbers, symbols) or other secret (e.g., a cryptographic key). In some examples, passwords may be used in systems both for human users and applications.

Passwords, including other secrets such as secret keys and credentials, may be set and forgotten about. In some cases, organizations may perform rotation (changing) of passwords on a time-based schedule (e.g., every 90 days or every year). This approach may work, but may not go far enough in securing the integrity and safety of resources.

The examples described herein increase the integrity and safety of local and network resources by continually validating a password against known breached and commonly used passwords. The examples described in this disclosure may allow administrators to monitor the integrity of the passwords used in their systems, especially those used for administrative or server-to-server communication where improper use of the passwords carries increased risk of damage.

In some examples, automatic alerts may be generated or passwords may be automatically updated for passwords that are found to be weak. This may enable systems that rely on passwords for access control to become stronger from a security perspective.

In some approaches, systems can automatically expire or change passwords. For example, these systems may use scripts that are custom built for the system being maintained. These tools may expire or change passwords on a set schedule or may even watch for patterns in usage of a user that has a password and may trigger a password change. However, in these approaches, damage may have already been done due to a weak password in terms of it being breached previously or being commonly used.

The examples described herein provide for automatic expiration of a password based on an integrity score of the password. The integrity score may be an indication of the likelihood that the password may become compromised. In some examples, a password's integrity score may be determined by using a password integrity system to assign the integrity score to the password based on a set of criteria, including the password's potential inclusion in a set of compromised passwords. Actions may be performed based on the integrity score. For example, the password may be automatically expired and/or changed if the integrity score is below an integrity threshold. By continually checking the integrity of passwords in a system, and marking low integrity passwords as expired, the password security in a system may be continually improved.

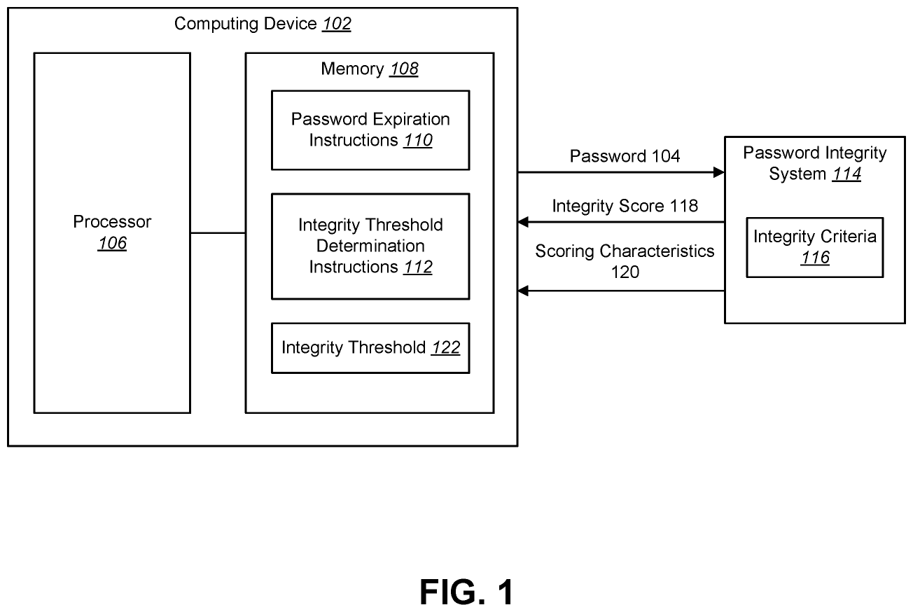

FIG. 1 is a block diagram of an example of a computing device 102 that may perform automatic password expiration based on password integrity. The computing device 102 may be an electronic device, such as a server computer, a personal computer, a smartphone, a tablet computer, etc. The computing device 102 may include and/or may be coupled to a processor 106 and/or a memory 108. In some examples, the computing device 102 may include a display and/or an input/output interface. In some examples, the computing device 102 may be in communication with (e.g., coupled to, have a communication link with) an external device (e.g., a server computer, a personal computer, a smartphone, a tablet computer, etc.). The computing device 102 may include additional components (not shown) and/or some of the components described herein may be removed and/or modified without departing from the scope of this disclosure.

The processor 106 may be any of a central processing unit (CPU), a semiconductor-based microprocessor, graphics processing unit (GPU), field-programmable gate array (FPGA), an application-specific integrated circuit (ASIC), and/or other hardware device suitable for retrieval and execution of instructions stored in the memory 108. The processor 106 may fetch, decode, and/or execute instructions (e.g., password expiration instructions 110, integrity threshold determination instructions 112) stored in the memory 108. In some examples, the processor 106 may include an electronic circuit or circuits that include electronic components for performing a function or functions of the instructions (e.g., password expiration instructions 110, integrity threshold determination instructions 112). In some examples, the processor 106 may perform one, some, or all of the functions, operations, elements, methods, etc., described in connection with one, some, or all of FIGS. 1-5.

The memory 108 may be any electronic, magnetic, optical, or other physical storage device that contains or stores electronic information (e.g., instructions and/or data). The memory 108 may be, for example, Random Access Memory (RAM), Electrically Erasable Programmable Read-Only Memory (EEPROM), a storage device, an optical disc, and the like. In some examples, the memory 108 may be volatile and/or non-volatile memory, such as Dynamic Random Access Memory (DRAM), EEPROM, magnetoresistive random-access memory (MRAM), phase change RAM (PCRAM), memristor, flash memory, and the like. In some implementations, the memory 108 may be a non-transitory tangible machine-readable storage medium, where the term “non-transitory” does not encompass transitory propagating signals. In some examples, the memory 108 may include multiple devices (e.g., a RAM card and a solid-state drive (SSD)).

In some examples, the computing device 102 may include an input/output interface through which the processor 106 may communicate with an external device or devices (not shown), for instance, to receive and store information (e.g., a password 104, integrity score 118, scoring characteristics 120). The input/output interface may include hardware and/or machine-readable instructions to enable the processor 106 to communicate with the external device or devices. The input/output interface may enable a wired or wireless connection to the external device or devices (e.g., personal computer, a server computer, a smartphone, a tablet computer, etc.). The input/output interface may further include a network interface card and/or may also include hardware and/or machine-readable instructions to enable the processor 106 to communicate with various input and/or output devices, such as a keyboard, a mouse, a display, a touchscreen, a microphone, a controller, another apparatus, electronic device, computing device, etc., through which a user may input instructions into the computing device 102.

In some examples, the processor 106 may receive a password 104 from an automated system. For example, the processor 106 may receive the password 104 from a web service (e.g., networked service). In another example, an automated system may generate the password 104 and may send the password 104 to the processor 106.

In other examples, the processor 106 may receive the password 104 from a user interface. For example, the computing device 102 may communicate with a user interface that provides a password 104. In some cases, the user interface may be implemented on an external device. In other cases, the user interface may be implemented on the computing device 102. In some examples, the user interface may be a graphical user interface into which a user enters the password 104.

When a user attempts to access resources using an application, the user may be prompted to enter the password 104 into the user interface. The application and/or user interface may communicate the password 104 to the processor 106. In some examples, the processor 106 may receive the password 104 directly from the application and/or user interface. In other examples, the processor 106 may receive the password 104 from a web service acting as an intermediary for the application and/or user interface.

In some examples, the processor 106 may implement password expiration instructions 110 to determine whether to expire a password 104 based on an integrity score 118. The processor 106 may send a password 104 to a password integrity system 114 to evaluate the password 104 against integrity criteria 116. For example, the processor 106 may continually validate the integrity of a password 104 by taking the password 104 as input and validating the password 104 against a configured password integrity system 114. In some examples, the password 104 may be sent to the password integrity system 114 in real time during application authentication. For example, a user may be asked to enter a password 104 into an authentication application. This password 104 may be sent to the password integrity system 114. In some examples, the password 104 may be sent to the password integrity system 114 in plain text or as a hashed value.

In some examples, the password integrity system 114 may be implemented on a separate computing device. For example, the computing device 102 may communicate with a remote computing device hosting the password integrity system 114 over a network. The computing device 102 may send the password 104 to the password integrity system 114 over the network.

In other examples, the password integrity system 114 may be implemented by the computing device 102. For example, the functionality of the password integrity system 114 described herein may be implemented by the processor 106.

In yet other examples, the methods for automatic password expiration described herein may be implemented by a computing service. For example, the password expiration instructions 110, integrity threshold determination instructions 112 and/or password integrity system 114 may be implemented on a cloud computing platform. In this example, functions to perform the described methods for automatic password expiration may be implemented (e.g., executed) in a cloud-based computing service environment.

In some examples, the password integrity system 114 may include a set of multiple password integrity services. The password integrity system 114 may evaluate the password 104 against a set of integrity criteria 116. The password integrity system 114 may determine an integrity score 118 for the password 104. In some examples, the integrity criteria 116 used by the password integrity system 114 to determine the integrity score 118 may be dynamic and may change over time. The integrity criteria 116 may include rules for determining the integrity score 118.

In some examples, the integrity criteria 116 used to determine the integrity score 118 may be based on a number of data breaches using the password 104. For example, the password integrity system 114 may determine whether the password 104 was included on a list of known compromised passwords. In some examples, the known compromised passwords list may be built from publicly available lists that contain compromised passwords from systems that have been breached. In some examples, the number of data breaches used to determine the integrity score 118 may be the number of occurrences of the password 104 in data breaches. In other examples, the integrity criteria 116 used to determine the integrity score 118 may be a Boolean of whether or not the password 104 has ever shown up in a data breach.

In some examples, the integrity criteria 116 used to determine the integrity score 118 may be based on a number of times the password 104 has been used in a period of time. For example, this integrity criteria 116 may be used to determine whether the password 104 is commonly used by multiple users and/or applications. In some examples, the password integrity system 114 may determine whether the password 104 matches other passwords used by multiple users.

The processor 106 may receive, from the password integrity system 114, an integrity score 118 for the password 104 and scoring characteristics 120 indicating the integrity criteria 116 that contributed to the integrity score 118. Upon determining the integrity score 118, the password integrity system 114 may return the integrity score 118 to the computing device 102. In some examples, the password integrity system 114 may also return a set of scoring characteristics 120 that contributed to that score.

In some examples, the integrity score 118 may be based on a pattern that indicates an attack. For example, the integrity score 118 may be based on whether the password 104 is found in a single data breach or was found to be used multiple times (e.g., five or more times) in a recent time period. It should be noted that other examples of integrity criteria 116 may be used to determine the integrity score 118 of the password 104.

The processor 106 may automatically expire the password 104 in response to the integrity score 118 being less than an integrity threshold 122. The integrity threshold 122 may be a value that represents a minimum integrity score 118 that is acceptable for authentication. If the integrity score 118 is below the integrity threshold 122, then the password 104 may be automatically expired as being insecure. If the password 104 equals or is greater than the integrity threshold 122, then the processor 106 may accept the password 104 for authentication.

In some examples, the processor 106 may execute integrity threshold determination instructions 112 to determine the integrity threshold 122 based on the scoring characteristics 120. For example, the integrity threshold 122 may be higher for administrative communication and server-to-server communication than for other communication. The scoring characteristics 120 may indicate what integrity criteria 116 was used to assign the integrity score 118. Different integrity thresholds 122 may be used for different integrity criteria 116. For example, one integrity threshold 122 may be used if the password 104 is included in a list of known compromised passwords and another integrity threshold 122 may be used if the password 104 is found to be a commonly used password but is not currently compromised.

If the password 104 is known to have a low integrity score 118 (e.g., the integrity score 118 is less than the integrity threshold 122), the processor 106 may automatically expire the password 104 or alert another system of the integrity issue. As used herein, the term “expire” in relation to a password 104 refers to marking the password 104 as no longer valid for authentication. In some examples of password expiration, a flag or other setting may be set to indicate that the password 104 is not valid for use in authentication. In some examples, the password expiration may be enforced by prompting the user or application in real-time to select a different password 104 in response to a real-time low integrity check (e.g., a low integrity score 118) of the password 104. The processor 106 may determine whether the new password 104 receives a better integrity score 118 (e.g., the integrity score 118 is equal to or greater than the integrity threshold 122) before allowing the user to continue. In other examples, a user or application may be forced to select a new password 104 upon the next login.

As used herein, the term “automatically expire the password” refers to setting the password 104a as invalid (i.e., expired) by a computing device (e.g., processor 106) without user interaction. In other words, automatic expiration of the password refers to a computing process that marks the password as invalid without being directed by a user (e.g., administrator).

In other examples, the processor 106 may programmatically update the password 104 in response to the integrity score 118 being less than the integrity threshold 122. For example, the processor 106 may cause an application requesting authentication to generate or acquire a new password 104 with an integrity score 118 greater than the integrity threshold 122 without user interaction. In some examples, programmatically updating the password 104 may include updating the password 104 in a password manager application. In other examples, programmatically updating the password may include the processor 106 instructing an application to generate or acquire a new password 104 from a credential service.

In some examples, the processor 106 may validate the integrity of passwords 104 in an offline manner. For example, the processor 106 may provide the passwords 104 to the password integrity system 114 in an offline manner. In other words, the password validation may occur when a user is offline (e.g., not connected to the computing device 102) or outside an authentication procedure. For example, the processor 106 may send a stored password 104 to the password integrity system 114 to evaluate the password 104 as databases of known threats are updated. The processor 106 may mark low-scoring passwords 104 as expired. The processor 106 may force the user or application to choose a new password 104 on the next authentication.

In some examples, the processor 106 may integrate the password integrity check with password storage locations. The processor 106 may also execute the password integrity check on a periodic basis. It is in this continual validation that the password integrity becomes more powerful and increases the security of the underlying system that stores the passwords.

Password integrity may be checked in an online or offline manner. In some examples, password integrity may be checked in an online manner when a user provides a password 104 in real time. In other examples, offline password integrity checking may allow the password integrity check to run on a periodic basis. As the configured password integrity system 114 becomes broader and stronger, the continual offline validation may help to further identify low integrity passwords 104. The ability to continually update the integrity criteria 116 used by the password integrity system 114 may also offer the ability to keep the password integrity system 114 up-to-date with recently disclosed threats and trigger alerts if suspicious activity is detected.

In some examples, a process to periodically perform a validation of password integrity for stored passwords 104 may be performed. The periodic password integrity validation may be implemented as a process on the computing device 102 and/or password integrity system 114. For example, the computing device 102 may access a data store of passwords (e.g., in-use passwords) according to a scheduling cycle. The stored passwords may be provided to the password integrity system 114, which determines integrity scores 118 for the stored passwords. This may be accomplished as described above.

The computing device 102 or the password integrity system 114 may take an action on the stored passwords based on the integrity scores 118 and an integrity threshold 122. For example, the computing device 102 or the password integrity system 114 may automatically expire a stored password 104 that has an integrity score 118 less than the integrity threshold. In other examples, the computing device 102 or the password integrity system 114 may generate an alarm and/or flag a stored password 104 that has an integrity score 118 less than the integrity threshold. This periodic password integrity validation may provide on-going protections in addition to the point-in-time protection described above in connection with real-time password integrity validation. Furthermore, the periodic password integrity validation may be performed regardless of whether a user is logged in. This may be an effective counter measure to certain security risks (e.g., credential stuffing).

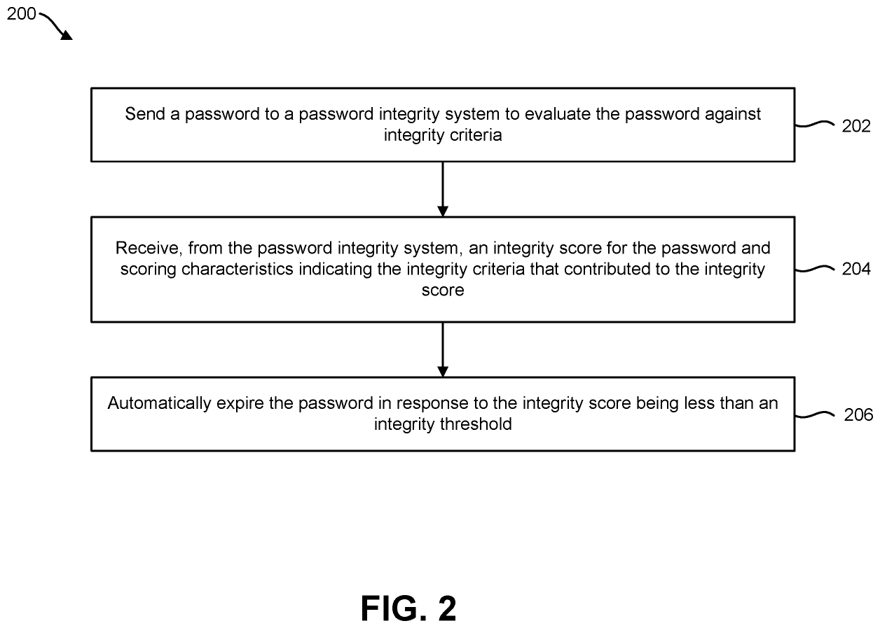

FIG. 2 is a flow diagram illustrating an example of a method 200 for automatic password expiration based on password integrity. The method 200 for automatic password expiration may be performed by, for example, the processor 106 of a computing device 102.

The processor 106 may send 202 a password 104 to a password integrity system 114 to evaluate the password against integrity criteria 116. In some examples, the password integrity system 114 may include multiple password integrity checking services for validation of the password's integrity. In other examples, the password integrity system 114 may include a single password integrity checking service.

In some examples, the integrity criteria 116 used by the password integrity system 114 to determine an integrity score 118 may be dynamic and changes over time. For example, the integrity criteria 116 used to determine the integrity score 118 may be based on a number of data breaches using the password 104. In another example, the integrity criteria 116 used to determine the integrity score 118 may be based on a number of times the password 104 has been used in a period of time. For example, the password integrity system 114 may determine how many times the password 104 matches the passwords (e.g., in-use passwords or previously-used passwords) of other users.

In some examples, the password 104 may be sent 202 to the password integrity system 114 in real time during application authentication. In other examples, the password 104 may be sent 202 to the password integrity system 114 periodically (e.g., in an offline manner). For example, a stored password 104 may be sent to the password integrity system 114 to evaluate password integrity on a periodic basis.

The processor 106 may receive 204, from the password integrity system 114, an integrity score 118 for the password 104 and scoring characteristics 120 indicating the integrity criteria 116 that contributed to the integrity score 118. In some examples, the integrity score 118 may indicate the likelihood of the password 104 becoming insecure (e.g., compromised). In some examples, the integrity score 112 may be a gradient scale indicating the likelihood of the password becoming insecure.

In some examples, the scoring characteristics 120 may indicate that the integrity criteria 116 included a number of times that the password 104 is used. For example, the integrity criteria 116 that contributed to the integrity score 118 may include the number of times the password 104 matches in-use passwords and/or previously-used passwords for multiple users. In another example, the scoring characteristics 120 may indicate that the integrity criteria 116 that contributed to the integrity score 118 included a number of times that the password 104 was included in a list of known compromised passwords.

The processor 106 may automatically expire 206 the password 104 in response to the integrity score 118 being less than an integrity threshold 122. In some examples, the integrity threshold 122 may be higher for administrative communication and server-to-server communication than for other communication.

In some examples, the processor 106 may prompt a user in real-time to select a different password 104 in response to a real-time low integrity check of the password 104. In other examples, a low-scoring password 104 may be marked as expired and forces a user to choose a new password 104 on the next authentication.

In an example of periodic password integrity validation, a low-scoring password 104 may be marked as expired. In this case, a user may be forced to choose a new password 104 on the next authentication. It should be noted that the periodic password integrity validation may be performed and a password 104 may be expired regardless of whether a user is logged in.

In some examples, the processor 106 may programmatically update the password 104 in response to the integrity score 118 being less than the integrity threshold 122. For example, the processor 106 may cause an application requesting authentication to generate or acquire a new password 104 with an integrity score 118 greater than the integrity threshold 122 without user interaction.

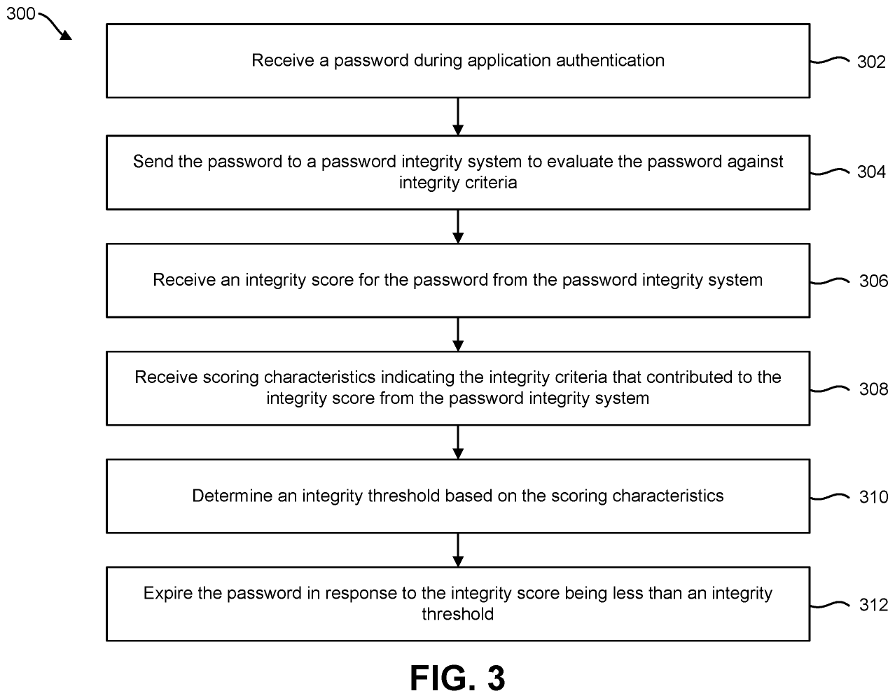

FIG. 3 is a flow diagram illustrating another example of a method 300 for automatic password expiration based on password integrity. The method 300 for automatic password expiration may be performed by, for example, the processor 106 of a computing device 102.

The processor 106 may receive 302 a password 104 during application authentication. For example, a user may be prompted to enter the password 104 into an authentication user interface for application authentication. In another example, an application may provide the password 104 to the processor 106 without user interaction.

The processor 106 may send 304 the password 104 to a password integrity system 114 to evaluate the password against integrity criteria 116. In some examples, the integrity criteria 116 used to determine the integrity score 118 may be based on a number of data breaches using the password 104. In other examples, the integrity criteria 116 used to determine the integrity score 118 may be based on a number of times the password has been used by one or multiple users in a period of time.

The processor 106 may receive 306 an integrity score 118 for the password 104 from the password integrity system 114. In some examples, the integrity score 118 may indicate the likelihood of the password 104 becoming insecure (e.g., compromised).

The processor 106 may receive 308 scoring characteristics 120 indicating the integrity criteria 116 that contributed to the integrity score 118 from the password integrity system 114. In some examples, the scoring characteristics 120 may indicate that the integrity criteria 116 included a number of times that the password 104 is used. For example, the integrity criteria 116 that contributed to the integrity score 118 may include the number of times the password 104 matches in-use passwords and/or previously-used passwords for multiple users. In another example, the scoring characteristics 120 may indicate that the integrity criteria 116 that contributed to the integrity score 118 included a number of times that the password 104 was included in a list of known compromised passwords.

The processor 106 may determine 310 an integrity threshold 122 based on the scoring characteristics 120. For example, the integrity threshold 122 may be higher for administrative communication and server-to-server communication than for other communication. The scoring characteristics 120 may indicate what integrity criteria 116 was used to assign the integrity score 118. Different integrity thresholds 122 may be used for different integrity criteria 116. For example, one integrity threshold 122 may be used if the password 104 is included in a list of known compromised passwords and another integrity threshold 122 may be used if the password 104 is found to be a commonly used password but is not currently compromised.

The processor 106 may expire 312 the password 104 in response to the integrity score 118 being less than an integrity threshold 122. For example, the processor 106 may prompt a user in real-time to select a different password 104 in response to the integrity score 118 being less than an integrity threshold 122. In other examples, a low-scoring password 104 may be marked as expired and forces a user to choose a new password 104 on the next authentication.

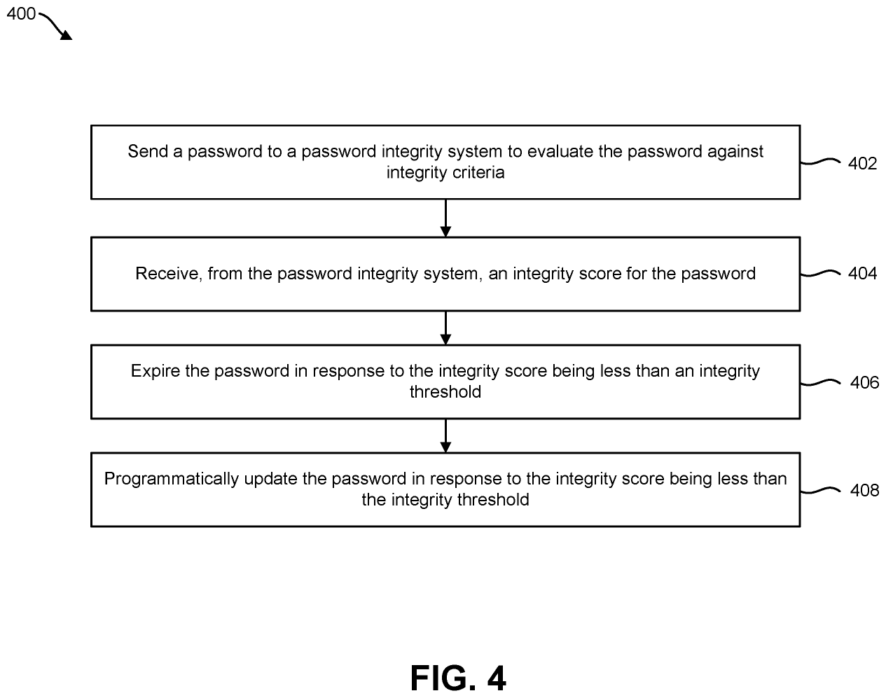

FIG. 4 is a flow diagram illustrating yet another example of a method 400 for automatic password expiration based on password integrity. The method 400 for automatic password expiration may be performed by, for example, the processor 106 of a computing device 102.

The processor 106 may send 402 a password 104 to a password integrity system 114 to evaluate the password against integrity criteria 116. This may be accomplished as described in FIG. 2. In some examples, an application may provide the password 104 to the processor 106 without user interaction.

The processor 106 may receive 404, from the password integrity system 114, an integrity score 118 for the password 104. In some examples, the integrity score 118 may indicate the likelihood of the password 104 becoming insecure (e.g., compromised). In some examples, the integrity score 112 may be a gradient scale indicating the likelihood of the password becoming insecure.

The processor 106 may expire 406 the password 104 in response to the integrity score 118 being less than an integrity threshold 122. For example, the processor 106 may determine whether the received integrity score 118 is less than the integrity threshold 122. If the integrity score 118 is less than the integrity threshold 122, then the password 104 may be marked as expired and may not be used for authentication.

The processor 106 may programmatically update 408 the password 104 in response to the integrity score 118 being less than the integrity threshold 122. For example, the processor 106 may cause the application requesting authentication to generate or acquire a new password 104 with an integrity score 118 greater than the integrity threshold 122 without user interaction. In some examples, programmatically updating the password 104 may include updating the password 104 in a password manager application. In other examples, programmatically updating the password may include the processor 106 instructing an application to generate or acquire a new password 104 from a credential service.

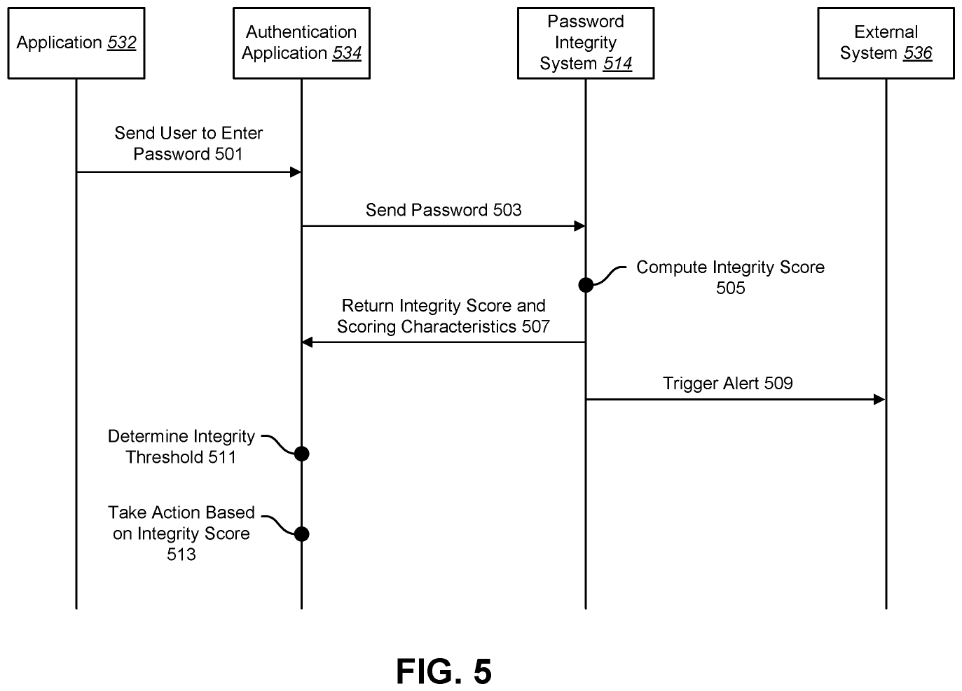

FIG. 5 is a sequence diagram for an example of automatic password expiration based on password integrity. In this example, an application 532 needing authentication may send 501 a user to an authentication application 534 to enter a password 104. In some examples, the authentication application 534 may be implemented in accordance with the computing device 102 described in FIG. 1. For example, the processor 106 may implement the authentication application 534.

Upon receiving the password 104, the authentication application 534 may send 503 the password 104 to the password integrity system 514. The password integrity system 514 may compute 505 an integrity score 118 for the password 104 based on integrity criteria 116. This may be accomplished as described in FIG. 1.

The password integrity system 514 may return 507 the integrity score 118 and scoring characteristics 120 to the authentication application 534. If the integrity score 118 is low, then the password integrity system 514 may trigger 509 an alert. For example, if the password integrity system 514 identifies patterns that suggest an attack, the password integrity system 514 may send an alert to an external system 536 or an operational team. Some examples of patterns that may indicate an attack are whether the password 104 was included in a list of known compromised passwords, whether the password 104 has been used more than a threshold number of times in a certain period of time, whether the password 104 has been used to access a threshold number of systems (e.g., applications) within a certain period of time, and/or whether the password 104 has been used to access a threshold number known compromised systems.

The authentication application 534 may determine 511 an integrity threshold 122 based on the scoring characteristics 120. For example, the authentication application 534 may determine 511 the integrity threshold 122 based on the integrity criteria 116 that were used to calculate the integrity score 118, as indicated by the scoring characteristics 120.

The authentication application 534 may take action 513 based on the integrity score 118. For example, if the integrity score 118 is less than the integrity threshold 122, the authentication application 534 may expire the password 104. In some examples, the authentication application 534 may also alert the external system 536 that the password 104 has a low integrity score 118.

It should be noted that while various examples of systems and methods are described herein, the disclosure should not be limited to the examples. Variations of the examples described herein may be implemented within the scope of the disclosure. For example, functions, aspects, or elements of the examples described herein may be omitted or combined.

1. A method, comprising:
sending a password to a password integrity system to evaluate the password against integrity criteria;
receiving, from the password integrity system, an integrity score for the password and scoring characteristics indicating the integrity criteria that contributed to the integrity score; and
automatically expiring the password in response to the integrity score being less than an integrity threshold.

2. The method of claim 1, wherein the integrity criteria used by the password integrity system to determine the integrity score is dynamic and changes over time.

3. The method of claim 1, wherein the integrity criteria used to determine the integrity score is based on a number of data breaches using the password.

4. The method of claim 1, wherein the integrity criteria used to determine the integrity score is based on a number of times the password has been used in a period of time.

5. The method of claim 1, wherein the integrity score is based on a pattern that indicates an attack.

6. The method of claim 1, further comprising sending a stored password to the password integrity system to evaluate password integrity on a periodic basis.

7. The method of claim 6, wherein a low-scoring password is marked as expired and forces a user to choose a new password on the next authentication.

8. A method, comprising:
receiving a password during application authentication;
sending the password to a password integrity system to evaluate the password against integrity criteria;
receiving an integrity score for the password from the password integrity system;
receiving scoring characteristics indicating the integrity criteria that contributed to the integrity score from the password integrity system;
determining an integrity threshold based on the scoring characteristics; and
expiring the password in response to the integrity score being less than the integrity threshold.

9. The method of claim 8, further comprising programmatically updating the password in response to the integrity score being less than the integrity threshold.

10. The method of claim 8, wherein the integrity threshold is higher for administrative communication and server-to-server communication than for other communication.

11. The method of claim 8, further comprising prompting a user in real-time to select a different password in response to a real-time low integrity check of the password.

12. A computing device, comprising:
a memory;
a processor coupled to the memory, wherein the processor is to:
send a password to a password integrity system to evaluate the password against integrity criteria;
receive, from the password integrity system, an integrity score for the password;
expire the password in response to the integrity score being less than an integrity threshold; and
programmatically update the password in response to the integrity score being less than the integrity threshold.

13. The computing device of claim 12, wherein the password integrity system comprises multiple password integrity checking services for validation of the password's integrity.

14. The computing device of claim 12, wherein the password is sent to the password integrity system in real time during application authentication.

15. The computing device of claim 12, wherein programmatically updating the password comprises generating a new password with an integrity score greater than the integrity threshold without user interaction.
